(19) United States
(12) Patent Application Publication
(10) Pub. No.: US 2007/0233285 A1
(43) Pub. Date: Oct. 4, 2007

(54) Apparatus Control System and Apparatus Control Method

(76) Inventor: Kakuya Yamamoto, Hyogo (JP)

Correspondence Address: WENDEROTH, LIND & PONACK L.L.P., 2033 K. STREET, NW, SUITE 800, WASHINGTON, DC, 20006, US

(21) Appl. No.: 11/662,546

(22) PCT Filed: Sep. 12, 2005
(86) PCT No.: PCT/JP05/16770

§ 371 Date: Mar. 12, 2007

(30) Foreign Application Priority Data
Sep. 14, 2004 (JP) 2004-266382

(51) Int. Cl. G05B 13/02

(52) U.S. Cl. 700/28

(57) ABSTRACT

The present invention realizes an apparatus control system and the like which can complete time consuming operations even when the user's operation changes during a coordinated operation, by adopting the change. The apparatus control device 120 includes a future status estimation unit 124 and a control apparatus decision unit 126 and the like, while an apparatus 130 includes an estimation information obtainment unit 131 and an operation content decision unit 132 and the like. With this configuration, an estimation of the future condition is changed in accordance with the change of a current condition related to the user, and operation content is decided based on the change of the estimation. Thus, even when the user's action changes, it is still possible to complete time consuming processing, or apparatus control prior to the user's action.

### TECHNICAL FIELD

The present invention relates to technology for controlling a coordinated operation of apparatuses, and particularly to an apparatus control system for controlling the coordinated operation using action patterns of a user.

### BACKGROUND ART

Conventionally, there is a method for coordinated operation of plural apparatuses (for example, household electric appliances) which sequentially controls operation using an operation of a household electric appliance as a trigger (See Patent Reference 1). This method is suitable for automating “sequential operations” that sequentially control household electric appliances. For example, it is suitable for automating a series of operations such as “switch on the DVD player, switch on the TV, switch external input of the TV to video input, start DVD playback, and switch on the air conditioner”. Patent Reference 1: Japanese Unexamined Patent Application Publication No. 2002-281574

### DISCLOSURE OF INVENTION

### Problems that Invention is to Solve

However, with the conventional method, a system which includes household electric appliances that require a certain period of time for control such as “controlling room temperature” by an air conditioner and “cooking rice” by an electric rice cooker has been introduced. In such a system, it is unable to respond to a change of a user's activity during the operation when the user wishes to change the completion time of the processing which requires a certain period of time.

In other words, the conventional method is unable to adapt to the change in the user's action when a control over the coordinated operation which includes the household electric appliances that require a certain period of time. As a result, there is a problem that the control is not completed in a preferred time and the method lacks convenience.

Accordingly, an object of the present invention, which has been conceived in light of the aforementioned problems, is to provide an apparatus control system that can suitably complete time-consuming processing during the coordinated operation in response to the changes.

### Means to Solve the Problems

In order to solve the problem above, the apparatus control system according to the present invention is an apparatus control system including a sensor which obtains action information indicating an environment related to a user or an action of the user; an apparatus control device which estimates a future status of the user based on the action information obtained by the sensor and a transition probability that varies depending on an elapsed time from the current status, and generates estimation information indicating the estimated status; and an apparatus which operates according to the estimation information generated by the apparatus control device.

With this configuration, since estimation of future status is changed according to the transition probability change along with the elapsed time from the user's current status, and operation content of the apparatus is decided based on the estimation change, a system which can control apparatuses based on the changes can be realized.

In addition, the apparatus control system in one aspect of the invention, in which the apparatus control device includes: an action-status relationship management unit operable to hold action-status relationship information indicating a relationship between the action information and a possible user status; a current status judgment unit operable to judge the current status of the user based on the action-status relationship information; an inter-status relationship management unit operable to hold inter-status relationship information indicating a relationship between two possible user statuses; a future status estimation unit operable to estimate the user's future status using the current status judged by the current status judgment unit and the inter-status relationship information, and to identify estimation information indicating a result of the estimation; a status-apparatus relationship management unit operable to hold status-apparatus relationship information indicating a relationship between the estimated future status and an apparatus to be controlled; and a control apparatus decision unit operable to decide an apparatus to be controlled using the estimated future status and the status-apparatus relationship information, and notify the apparatus of the estimation information.

Furthermore, the apparatus control device may further include an information collection unit operable to collect history information indicating an action history of the user, and the inter-status relationship management unit is further operable to modify the inter-status relationship information using the collected history information.

In addition, the apparatus according to the present invention includes: a judgment condition management unit operable to hold a judgment condition related to control of the apparatus; an estimation information obtainment unit operable to obtain the estimation information from the apparatus control device; an operation content decision unit operable to decide operation content of the apparatus using the obtained estimation information and the judgment status; and an operation control unit operable to control the apparatus in accordance with the decided operation content.

In addition, the estimation information includes an elapsed time from the current status and a probability that transition to the future status occurs, and the operation content decision unit is operable to identify operation content based on the transition probability to the future status when the judgment status is satisfied.

In addition, the apparatus control device further estimates an intermediate status estimated in accordance with the elapsed time from the current status, further estimates the a future status of the user in accordance with the elapsed time from the intermediate status, and generates estimation information indicating the estimated future status.

Note that the present invention can be realized as an apparatus control system, an apparatus control system that includes characteristic configurations of the apparatus control device as steps, or a program for executing the steps on a personal computer. In addition, it is needless to say that the program can be widely distributed via storage medium such as DVD or transmitting medium such as the Internet.

### EFFECTS OF THE INVENTION

According to the apparatus control system of the present invention, since estimation of future status is changed according to the transition probability change along with the elapsed time from the user's current status, and operation of the apparatus is decided based on the estimation change. Thus it is possible to realize a system which can control apparatuses based on the changes even when the user's action changes, or can start processing prior to the user's action can be realized.

In addition, by reflecting the user's action and action history to an inter-status relationship table, inter-status relationship and past history can be learnt from experience of others, which enables more appropriate future status estimation.

### BRIEF DESCRIPTION OF DRAWINGS

FIG. 1 is a hardware block diagram showing an overview of the apparatus control system according to the present invention.

FIG. 2 is a block diagram showing a function configuration of the apparatus control system according to the present invention.

FIG. 3 is a diagram showing an example of an action-status relationship table.

FIG. 4 is a diagram showing an example of current status table.

FIG. 5 is a diagram showing an example of an inter-status relationship table.

FIG. 6 is a diagram showing an example of an inter-status relationship table.

FIG. 7 is a diagram showing an example of an inter-status relationship table.

FIG. 8 is a diagram showing an example of estimated status table.

FIG. 9 is a diagram showing an example of a status-apparatus relationship table.

FIG. 10 is a diagram showing an example of operation content decision table.

FIG. 11 is a flowchart showing processing flow performed by the apparatus control device.

FIG. 12 is a flowchart showing processing flow of the apparatuses.

FIG. 13 is a diagram showing an example of a current status table.

FIG. 14 is a diagram showing an example of a current status table.

FIG. 15 is a diagram showing an example of an estimated status table.

FIG. 16 is a diagram showing an example of an estimated status table.

### NUMERICAL REFERENCES

10 Apparatus Control System
20 LAN
30 Electric light
40 TV
50 Air conditioner (restroom)
60 Electric water boiler (bathroom)
70 Electric carpet
80 Network
90 Mobile terminal
110 Sensor
120 Apparatus control device
121 Action-status relationship management unit
122 Current status judgment unit
123 Inter-status relationship management unit
124 Future status estimation unit
125 Status-apparatus relationship management unit
126 Control apparatus decision unit
130 Apparatus
131 Estimation information obtainment unit
132 Operation content decision unit
133 Judgment status management unit
134 Operation control unit

### BEST MODE FOR CARRYING OUT THE INVENTION

Embodiments of the present invention is described hereafter with reference to the drawings. Note that although the present invention shall be described with reference to the drawings in the embodiments below, the present invention is not limited by the drawings.

### EMBODIMENT

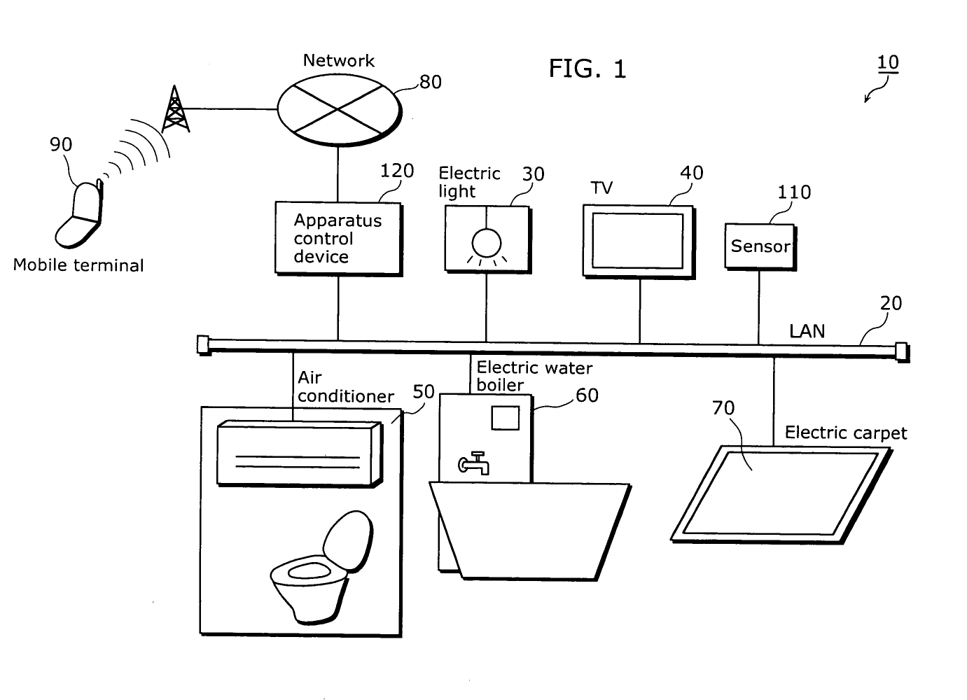

FIG. 1 is a hardware configuration diagram showing an overview of the apparatus control system 10 according to the first embodiment. The apparatus control system 10 is a system which estimates an action of a user, and controls a coordinated operation for household electric appliances or electric devices (hereinafter referred to as “apparatuses”) based on the estimation result. The system includes a sensor 110, an apparatus control device 120, an electric light 30, a TV 40, an air conditioner 50, an electric boiler 60, an electric carpet 70, and a mobile terminal 90 which are connected via a LAN 20 such as Ethernet (trademark) (and an apparatus control device 120 and a network 80 such as the Internet and the like). With regard to controlling the coordinated operation by the apparatus control device 120, remote control can be performed from the mobile terminal 90.

Note that the electric light 30, the TV 40, the air conditioner 50, the electric boiler 60, and the electric carpet 70 are examples of the apparatuses, and may also be other apparatuses.

Here, “apparatuses” according to the present invention specifically includes: household electric appliances such as air conditioner and washing machine; audio-visual equipments such as TV, speaker, and camera; electric appliances which can input and output information such as light, bell, switch, vibrator, and sensor; information display apparatuses such as LCD and head-mounted display; small appliances which can input and output information such as stuffed-toy shaped robot, umbrella with lamp, and hanger with LCD; information communication devices such as telephone and fax; information processing devices such as personal computer and home server; mobile devices such as mobile phone and GPS terminal; public devices such as automatic door and traffic signal; information providing servers such as weather forecast server, traffic information server, and ranking information server; servers which handle information on individual or groups such as mail server, scheduler server, TV program recording server, and household bookkeeping server; servers which provide functions such as dictionary server, language translation server, sound recognition server, image recognition server, format conversion server, data evaluation server, movement detection server, hard disk rental server, and authentication server; information providers such as IC card and RFID (Radio Frequency Identification Device) and others.

In addition, “a sensor” according to the present invention is a device or an apparatus which obtains information regarding a user that can be provided to the apparatuses. The sensor includes: apparatuses operated by the user such as TV and electric light; apparatuses which recognize the user's action such as door sensor, video camera, GPS, thermometer, and attitude sensor; apparatuses which provide information that may affect the user's action such as traffic jam information providing server, weather forecast server, scheduler server, and mail server; apparatuses which are operated by others who could have influenced on user's action; apparatuses which recognize other's action, and other apparatuses and the like.

It is noted that “action information” according to the present invention includes information or data and the like, obtained by the sensor.

In addition, “a status” according to the present invention is user's status or peripheral status that the user is in. More specifically, the statuses include physical status, mental status, positional status, social status, and peripheral environment status. The physical status includes high body temperature, with an arm raised, walking, sleeping, and during meal and the like. The mental status includes: being tired, being happy, being in trouble, being stressed, being excited, and when the user is interested in a certain subject such as diet or health. The positional status includes an area where the user is in, a room, a distance from certain object or creature, a status in which the user is not on the first floor, or a status in which the user is moving or the like. The social statuses include: at work, at a meeting, conversing with superior, being monitored, having an immediate deadline for a project, almost late for a meeting, after a mistake, being lost one's way, having many tasks, being troubled by relationships, and when the user is in a street where crimes such as purse snatching often occurs. The peripheral environment statuses include: cold, narrow, noisy, unable to connect to the network, and statuses showing presence or characteristic of devices in the periphery.

It should be noted that the description of the terms above is listed in order to facilitate the understanding of the present embodiment, not to limit the present invention.

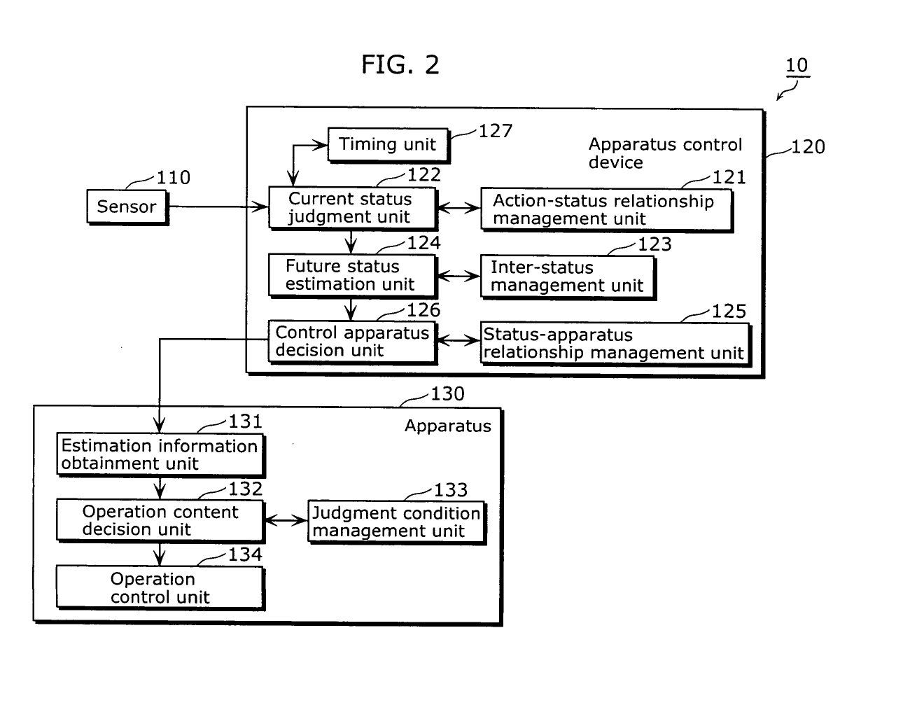

Each component of the apparatus control system 10 according to the first embodiment shall be specifically described hereafter. FIG. 2 is a block diagram showing a function structure of the apparatus control system 10. As shown in FIG. 2, the apparatus control system 10 includes the sensor 110, the apparatus control device 120, and the apparatus 130.

The sensor 110 is, for example, the TV 40, a remote controller (hereinafter referred to as “remote”) or an infrared sensor, and notifies action information showing a status where the user is or the user's action (operation of remote or movement of the user's position). Note that the sensor 110 may be the mobile terminal 90 including GPS function which enables identification of user's location.

The apparatus control device 120 is, for example, a personal computer and controls the whole apparatus control system 10, and communication between the apparatuses performed via the LAN 20. Furthermore, the apparatus control device 120 judges current status and estimates future status at the same time, and notifies the apparatus 130 of the estimation result. As shown in FIG. 2, the apparatus control device 120 includes the action-status relationship management unit 121, the current status judgment unit 122, the inter-status management unit 123, the future status estimation unit 124, the status-apparatus relationship management unit 125, the control apparatus decision unit 126, and the timing unit 127.

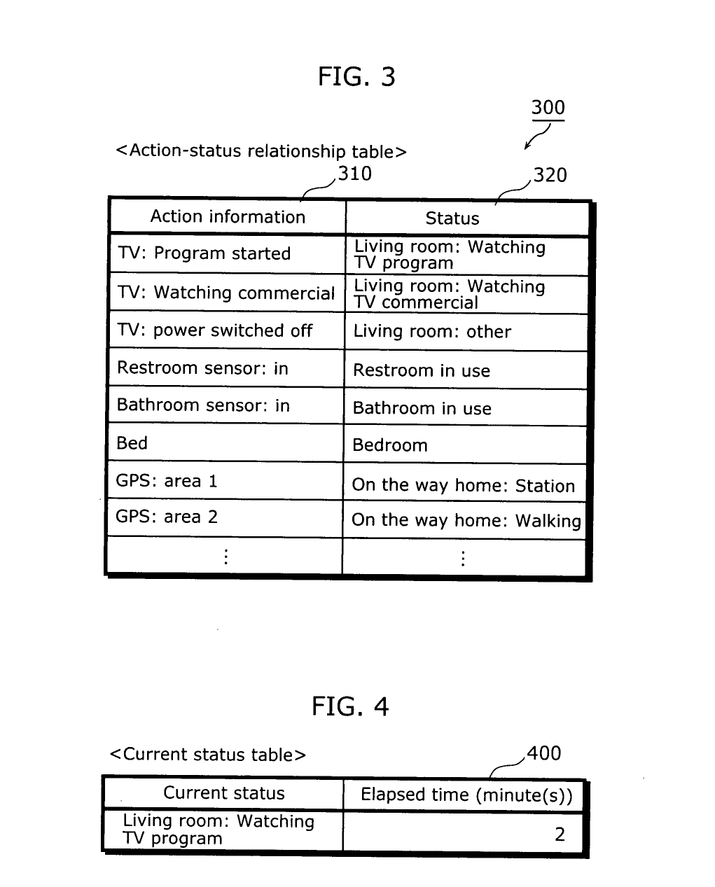

The action-status relationship management unit 121 includes memory device such as RAM, and manages information showing relationship between the action information obtained from the sensor 110 and the status which the user might be in (for example, action-status relationship table). FIG. 3 shows a specific example of an action-status relationship table.

The current status judgment unit 122 is, for example, a micro computer including a ROM or a RAM for storing a control program and controls the whole apparatus control device 120. Furthermore, the current status judgment unit 122 judges user's current status from the action information obtained from the sensor 110 and the action-status relationship table in the action action-status relationship management unit 121, and notifies the future status estimation unit 124 of the judgment result.

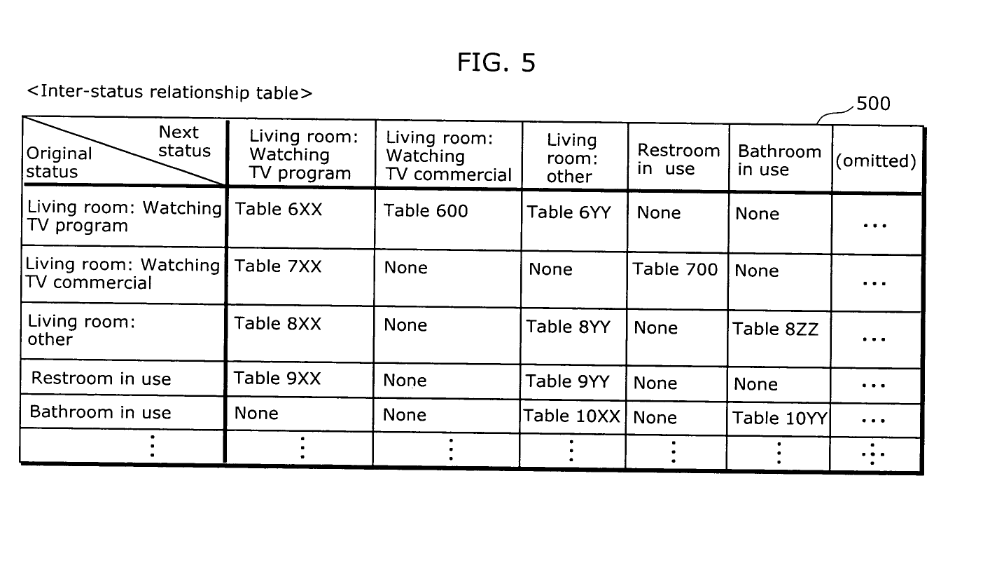

The inter-status relationship management unit 123 includes a memory device such as RAM, and manages information showing relationship between the statuses in which the user might be in (for example, a status-apparatus relationship table). FIG. 5 shows a specific example of an inter-status relationship table.

The future status estimation unit 124 estimates the user's future status (also referred to as next status) and notifies the control apparatus decision unit 126 of the estimation result.

The status-apparatus relationship management unit 125 includes a memory device such as RAM, and manages information showing the relationship between the statuses which the user might be in and the apparatuses (for example, inter-status relationship table). FIG. 9 shows a specific example of a status-apparatus relationship table.

The control apparatus decision unit 126 identifies a control object apparatus using the next status estimated in the future status estimation unit 124 and the status-apparatus relationship table in the status-apparatus relationship management unit 125, and sends estimated information (for example, elapsed time and transition probability) to the apparatus.

The timing unit 127 starts clocking after an instruction from the current status judgment unit 122, and periodically (for example, every 1 msec) notifies the current status judgment unit 122 of information indicating time measured in the timing unit.

The apparatus 130 is, for example, an air conditioner in the restroom and performs operation based on the instruction of the apparatus control device 120 (for example, controlling temperature in the restroom). The apparatus 130 includes an estimation information obtainment unit 131, an operation content decision unit 132, a judgment status management unit 133, and an operation control unit 134.

The estimation information obtainment unit 131 notifies estimated information (for example, elapsed time and transition probability) received from the control apparatus decision unit 126 to the operation content decision unit 132.

The operation content decision unit 132 decides the operation content of the apparatus 130 based on the estimated information obtained from the estimation information obtainment unit 131 (for example, elapsed time and transition probability) and information in the judgment condition management unit 133 for determining the operation content of the apparatus 130 (for example, an apparatus operation content decision table).

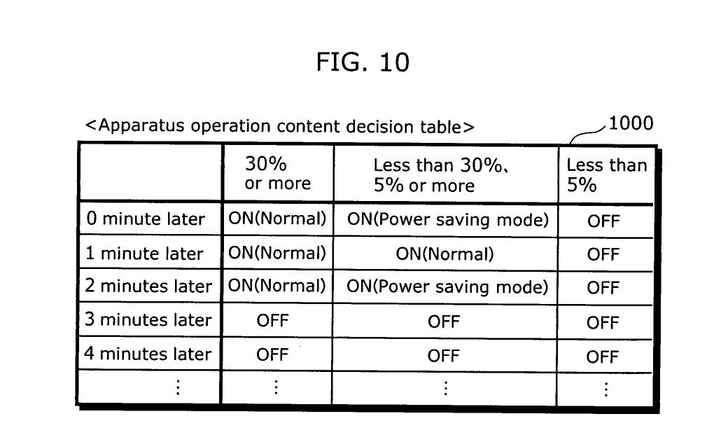

The judgment condition management unit 133 manages information indicating operation content of the apparatus 130 (for example, an apparatus operation content decision table). FIG. 10 shows a specific example of the apparatus operation content decision table.

The operation control unit 134 controls the operation of the apparatus 130 based on the result decided in the operation content decision unit 132.

As described above, according to the apparatus control system 10 of the present embodiment, by including the future status estimation unit 124 and the operation content decision unit 132 and the like, the estimation of the future status is changed in response to the change of inter-status transition probability along with elapsed time from the user's current situation. Thus, a system which can complete time-consuming processing and start processing prior to the user's action can be realized.

Next, operations of the apparatus control system 10 shall be described with reference to the drawings. A status is described hereafter as an embodiment of the present invention assuming that the user is watching a TV program in the living room of his/her house, and when estimating that the user may use the rest room in the future. The air conditioner in the rest room is controlled based on the estimation result. With the control above, the temperature of the rest room can be set at a suitable temperature when the user actually uses the rest room.

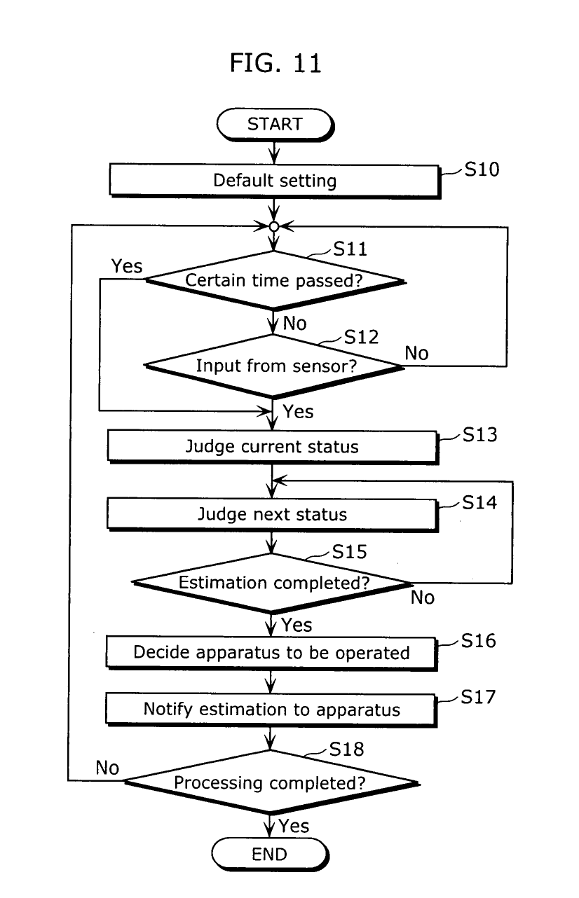

FIG. 11 is a flowchart showing a processing flow in the apparatus control device 120.

First of all, the current status judgment unit 122 performs initial setting (including instruction and setting instructed by the user) required for the main processing (S10), judges whether or not a predetermined time has passed using time information notified from the timing unit 127 (S11), or whether or not the action information has been inputted from the sensor 110 (S12).

When the predetermined time has passed (S11: Yes) or the action information has been inputted from the sensor 110 (S11: No and S12: Yes), the current status judgment unit 122 performs judgment of the current status using the current status measured before the predetermined time or inputted action information (S13).

More specifically, when the user starts watching a TV program in the living room of his/her house, the current status judgment unit 122 obtains “program started” as the user's action information from the TV which is the sensor 110.

Next, the current status judgment unit 122 identifies “TV: program started” from the action information column 310 using the action-status relationship table 300 (see FIG. 3) managed by the action-status relationship management unit 121, and identifies “living room: watching TV program” from the status column 320 as a status corresponding to the “TV: program started”.

Furthermore, the current status judgment unit 122 holds the “living room: watching TV program” in the current status table 400 and starts clocking of an elapsed time from the judgment (see FIG. 4).

In the example of the current status table 400 shown in FIG. 4, the current status is “Living room: watching TV program”, and the elapsed time since the judgment of the status is “2 minutes”. The elapsed time in the current status table 400 is renewed when each predetermined time has passed (for example, every minute), and the current status is renewed in accordance with the action information obtained from the sensor 110.

The future status judgment unit 124 subsequently estimates a next status in the future based on the current status specified in the current status judgment unit 122 (or further estimates future next status based on the estimated next status) (S14). More specifically, the future status estimation unit 124 estimates the next status using the inter-status relationship management table 500 (see FIG. 5) managed by the inter-status relationship management unit 123.

For example, in order to estimate the next status of “Living room: watching TV program”, the current status specified in the current status judgment unit 122, a row in which the original situation is “Living room: watching TV program” is specified. In this row, in the column of “Living room: watching TV program” noted “Table 6XX”, “Table 600” in the column of “Living room: watching TV commercial”, “Table 6YY” in the column of “Living room: others”. Thus these 3 statuses are estimated as a next status of the original status “Living room: watching TV program”. Estimation of the next status corresponding to each original situation is performed with reference to the separate tables such as “Table 6XX”, “Table 600”, and “Table 6YY”. On the contrary, in the inter-status relationship table 500, estimation of the next status is not performed since it is noted “None” in the rows of “Restroom in use” and “Bathroom in use”, which correspond to the column of “Living room: watching TV program”.

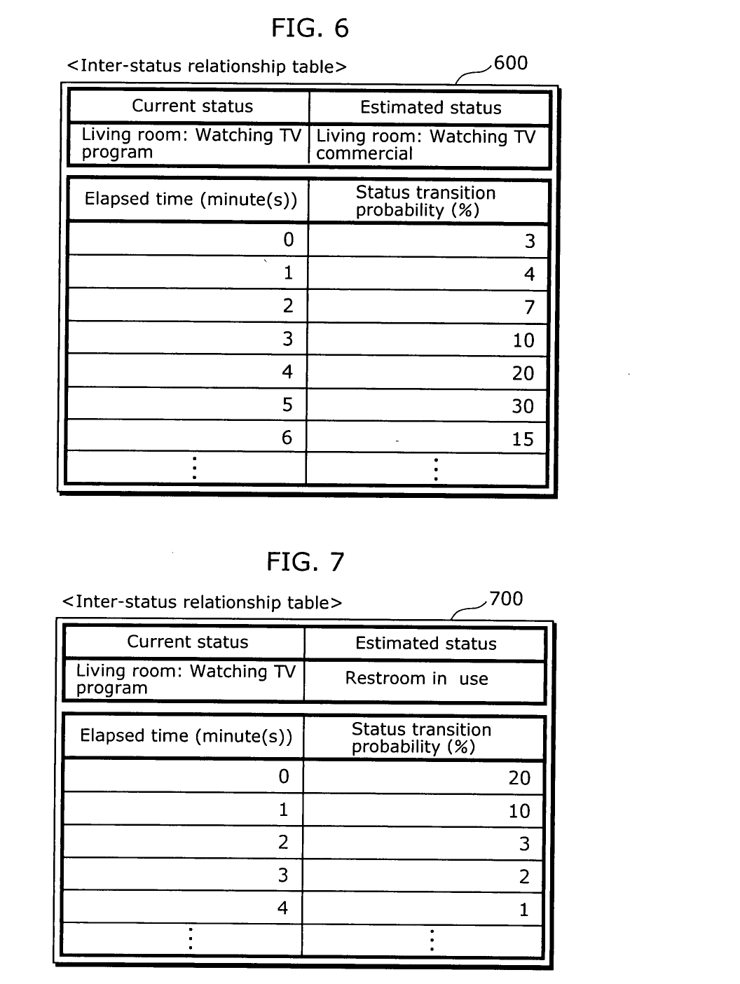

An inter-status relationship table 600 is a specific example of the “table 600” in FIG. 5, and a transition probability of changing to a status “Living room: watching TV commercial” after “Living room: watching TV program” when “Living room: watching TV commercial”. In the current status table 400 held in the current status judgment unit 122, the current status is “Living room: watching TV program”, and the elapsed time since the judgment of the status is “2 minutes”. Thus, a status transition probability corresponds to the elapsed time “two minutes” in FIG. 6 is “7%”. Likewise, the transition probability which the current status changes to the estimated status after one minute from now, or 3 minutes in the elapsed time from the current status, decided as “10%”. In the same manner, the transition probability is “20%” after two minutes from now, “30%” after three minutes from now, and “15%” after four minutes from now. As described above, the transition probability which the current status “Living room: watching TV program” to the status “Living room: watching TV commercial” when “Living room: watching TV commercial” is estimated as the next status, the transition probability is calculated as 7% now, 10% after one minute, 20% after two minutes, 30% after three minutes, and 15% after four minutes (the future status estimation unit 124 holds the calculated values).

Furthermore, the future status estimation unit 124 judges whether or not the estimation above is completed (S15). In the case where the estimation is completed (S15: Yes), the apparatus to be operated is decided (S16), and estimation information indicating the estimated result is notified to the apparatus (517).

Meanwhile, in the case where the estimation is not completed (514: No), returns to S14. Here, whether or not the estimation above is completed, may be judged once S14 is completed, or when S14 is completed for a predetermined times, twice, for example, or sequentially estimating next statuses, or S14 may be repeated until finally no further estimation can be performed, or combination of the methods above. In this embodiment, estimation is completed when S14 is repeated twice. Accordingly, S14 is repeated once more. Details of second S14 are described hereafter.

(Second S14) Since the 3 statuses are estimated in S14 above, a next status of each status is further estimated. In this description, only the next status of “Living room: watching TV commercial” will be described. In the inter-status relationship table 500, in the row of the original status is “Living room: watching TV commercial”, and the next statuses are “Living room: watching TV program” and “Restroom in use” lists description (in other words, not the listing “None”), and thus these two statuses are estimated as the next statuses. A specific example of the “table 700” in the column of “Restroom in use” is shown in FIG. 7.

In the inter-status relationship table 700, the status transition probability corresponding to the elapsed time 0 minute is “20%”, and thus using the status transition probability “7%” for transiting from “Living room: watching TV program” to “Living room: watching TV commercials” specified in the aforementioned FIG. 6, a transition probability to a status “Restroom in use” from the current status “Living room: watching TV program” and “Watching TV commercial” is “1.4%”, which is a multiplication of“7%” and “20%”.

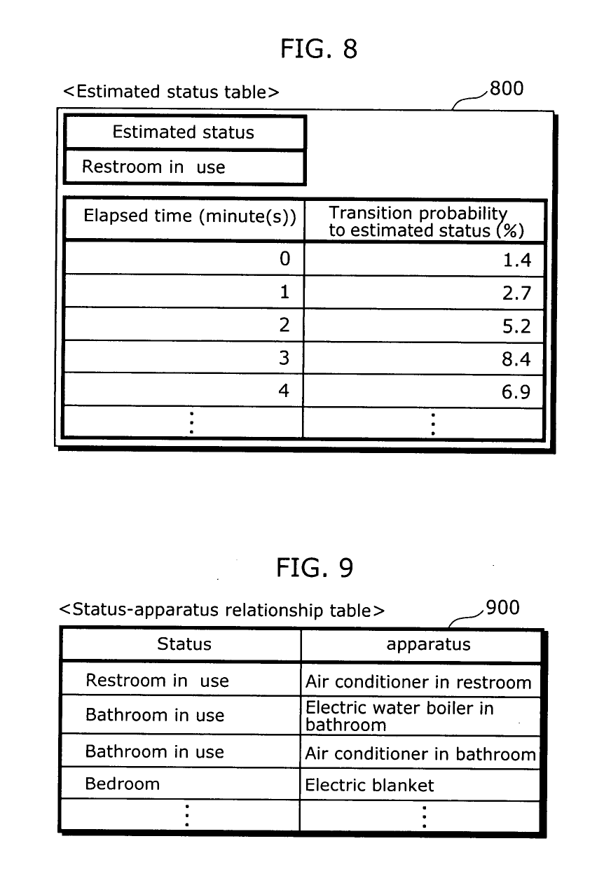

Accordingly, a list of the estimated statuses two steps from now is an estimation status table 800 in FIG. 8. To put it differently, an estimation status table 800 in FIG. 8 is a list of calculated transition probability of reaching an estimated status “Restroom in use” from the current status “Watching TV program” and the next status “Restroom in use” corresponding to the elapsed time after now (in other words, after two or more minutes from the current status). As described above, the transition probability of reaching the estimated status “Restroom in use” from the present status (or, two minutes after shifting to “Watching TV program”) to “Restroom in use” after “Watching TV commercial” is calculated as “1.4%”. In the same manner, the transition probability of reaching “Restroom in use” after one minute from the current status is a sum of the transition probability of two routes. In other words, the probability of reaching “Watching TV commercials” immediately after the current status and shifts to “Restroom in use” after one minute from the transition is “0.7%”, which is multiplication of “7%” in FIG. 6 and “10%” in FIG. 7. Meanwhile, the transition probability of changing to “Watching TV commercial” one minute from now, and to “Restroom in use” immediately after the shift is calculated as “2%”, by multiplying “10%” in FIG. 6 and “20%” in FIG. 7. Therefore, the transition probability is calculated as “2.7%” by adding “0.7%” and “2%” above.

Moreover, the transition probability of reaching “Restroom in use” after two minutes from the current status is a sum of the transition probability of three routes. In other words, the transition probability of shifting to “Restroom in use” two minutes after the transition to “Watching TV commercials” is “0.2%”, which is a multiplication of “7%” and “3%”. In addition, the transition probability of shifting to “Watching TV commercial” after one minute from the current status and to “Restroom in use” after one minute from the transition is “1.0%”, which is a multiplication of“10%” and “10%”. Furthermore, the transition probability of shifting to “Watching TV commercial” after two minutes from the current status and to “Restroom in use” immediately after the shift is “4.0%”, which is a multiplication of “20%” and “20%”. Thus, the transition probability is “5.2%”, a sum of “0.2%”, “1.0%”, and “4.0%” described above.

Likewise, the transition probability three minutes from now is calculated as “8.4%” from “7%×2%+10%×3%+20%×10%+30%×20%”, and the transition probability after four minutes is calculated as “6.9%” from “7%×1%+10%×2%+20%×3%+30%×10%+15%×20%”. As described above, the estimated status table 800 in FIG. 8 is generated by calculating transition probabilities of shifting to “Restroom in use after “Watching TV commercials” from the current status of “Watching TV program”.

Next, the control apparatus decision unit 126 decides an apparatus which is a control object based on the estimation result estimated in S14 above (S16). The apparatus to be controlled is decided using the status-apparatus relationship table 900 (see FIG. 9) managed by the status-apparatus relationship management unit 125. Each of the apparatuses is judged for the each of processing S14. From the apparatus-status relationship table 900 in FIG. 9, “Air conditioner in the restroom” can be specified as the apparatus to be controlled.

Finally, the control apparatus decision unit 126 notifies the estimation result of the apparatus 130 specified in S16 (S17). In this case, the control apparatus decision unit 126 notifies the air conditioner 50 in the restroom of the estimation information regarding “restroom in use” shown in FIG. 8.

With the processing above, the future status estimation processing in the apparatus control device 120 is completed.

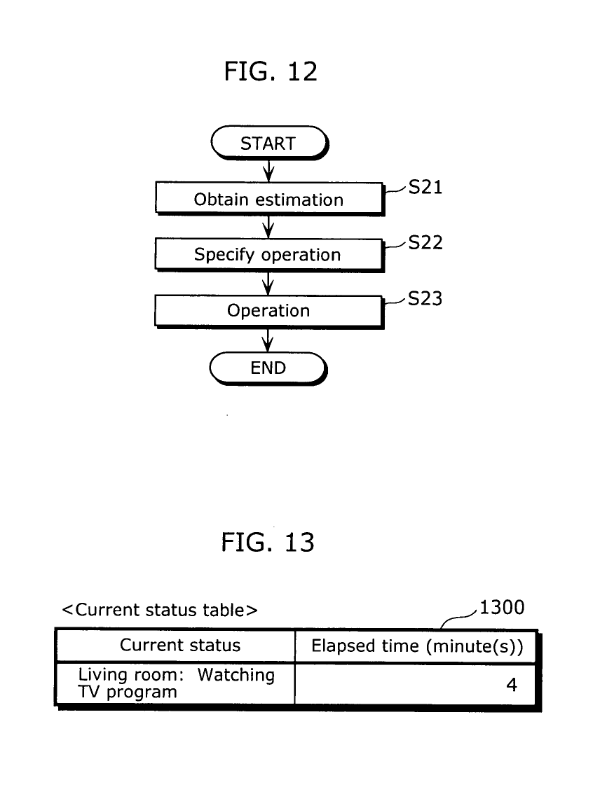

FIG. 12 is a flowchart showing a processing flow in the apparatus control device 120.

First of all, the estimation information obtainment unit 131 obtains the estimation result from the apparatus control device 120 (S21). For example, the estimation status table 800 generated in FIG. 11 is obtained as the estimation result.

Next, the operation content decision unit 132 decides content of operation in accordance with the obtained estimation result (S22). Specifically, the operation content decision unit 132 decides the operation content of the air conditioner 50 in the restroom using the apparatus operation content decision table 1000 (FIG. 10) managed by the judgment condition management unit 133. In this embodiment, as an operation of the air conditioner 50 in the restroom, there are “on (normal)”, “on (energy saving mode)”, and “off”. According to the abovementioned future status estimation processing, the status changes to “Restroom in use”, two minutes after “Watching TV program” at the transition probability of “5.2%”, which is “less than 30% and 5% or more”, and thus the operation content can be decided as “on (power saving mode)”. Here, from FIG. 8, since “1.4% after 0 minute” and “2.7% after one minute”, it can be judged as “off” from FIG. 10, in this embodiment, decision can be performed based on a priority “on (normal)>on (power saving mode)>off”.

Note that the operation content may be decided as other measures such as the highest transition probability and the transition probability to the nearest future.

Thus, the operation control unit 134 controls the apparatus 130 according to the content decided in the operation content decision unit 132 (S23). In other words, “on (power saving mode)” is set for the air conditioner in the restroom.

With the operation above, when the user is in a status which “Watching TV program”, the system estimates that the status changes to “Restroom in use” after the status of “Watching TV commercials”, and calculate the transition probability. The air conditioner 50 in the restroom starts heating when the estimated result is obtained and controlling for the user's future toilet use.

(Variation)

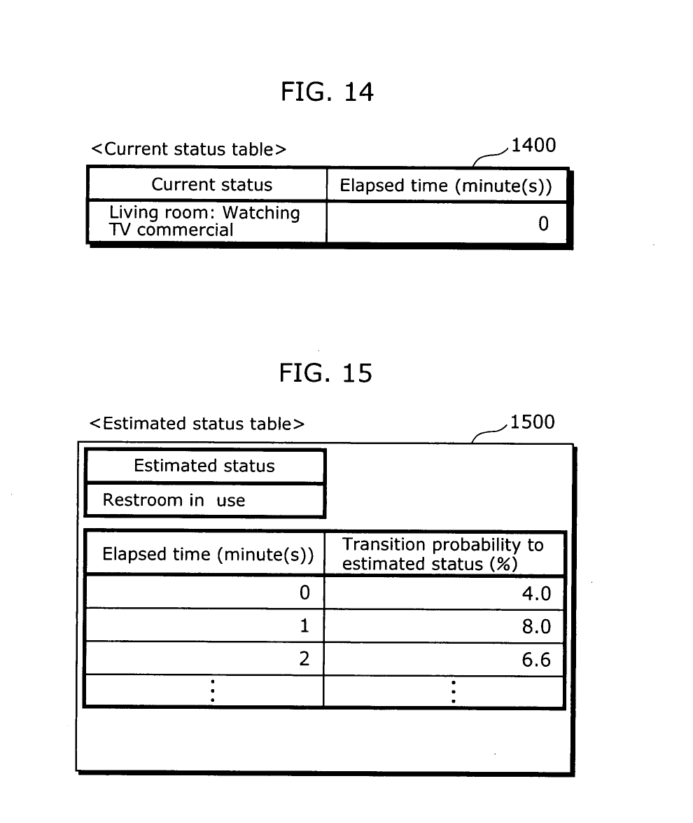

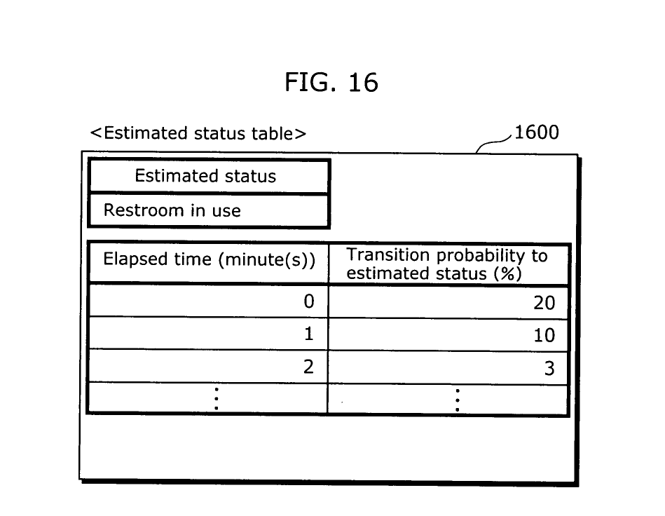

In the embodiment above, the estimation result regarding the current status which is after two minutes from the status of “Watching TV program” is presented, in this variation, a case in which two minutes has further passed (in other words, after four minutes) (see the current status table 1300 in FIG. 13), and a case where the status changes to “Watching TV commercials” (see the current status table 1400 in FIG. 14) are compared. In the case of the current status table 1300, estimation is performed in the same manner as the above embodiment, and transition probability shown in the estimation status table 1500 in FIG. 15. Meanwhile, in the case of the current status table 1400, the transition probability indicated in the estimation status table 1600 shown in FIG. 16 is calculated in the same manner. In the case where each of the estimation result is obtained by the air conditioner 50 in the restroom, both of them leads to “ON (normal)” operation.

With the operation above, in response to the user's status such as “Watching TV program” or “Watching TV commercial”, the apparatus 130 (or, the air conditioner 50 in restroom) is controlled in response to the change of the user's situation.

With the operation above, in the present invention, since operation content is decided after obtaining the estimation result of the future status which was sequentially estimated based on the current status, it is possible to realize an apparatus control system which can start controlling (of the apparatuses) prior to and along with user's action by completing time-consuming processing even when the user's action changes.

Note that the action-status relationship management unit 121, the inter-status relationship management unit 123, the status-apparatus relationship management unit 125, and the judgment status management unit 133 may be a file system in which each of the relationship tables and the status tables are stored.

Note that the action-status relationship management unit 121, the inter-status relationship management unit 123, the status-apparatus relationship management unit 125, and the judgment status management unit 133 may be modified, added, or deleted by downloading each of the relationship tables and the status tables.

Note that the information indicating inter-status relationship managed in the inter-status relationship management unit 123 may not be limited to tables, but also be other than tables. For example, the information may be a status graph representing the relationship as branches between each node.

Note that when the current status judgment unit 122 judges a status similar to the current status can be regarded as the current status even if the statuses do not perfectly match.

Note that the apparatus 130 may receive the status identification information notification when the status identified by the status identification information and the user's estimated status are matched after registering the apparatus control device 120 beforehand. For example, in the case of the air conditioner 50 in the restroom, the air conditioner 50 in the restroom may be registered beforehand as a notified party for the case where the status “Restroom in use” is estimated in the apparatus control device 120. In addition, an apparatus ID for identifying the air conditioner 50 in the restroom may be notified to the apparatus control device 120, and the apparatus control device 120 may decide an appropriated status using the apparatus ID, and the status-apparatus relationship table may be updated.

Note that the current status judgment unit 122 may judge plural statuses as current status depending on the type of statuses. For example, the current status may be judged as “working and taking a break”.

Note that the inter-status relationship management unit 123 may renew the inter-status relationship table using one or plural user's actions and action history. For example, a learning processing can be performed, for example, the transition probability of shifting to “restroom in use” from “Watching TV commercial” may be increased as the number of times the user goes to restroom during TV commercial increases. Alternatively, part of, or all of the inter-status relationship table may be shared with a group of people, and the content modification made in a user's inter-status relationship table maybe reflected to the inter-status relationship table of another user.

Note that in this embodiment, a time-consuming processing such as controlling temperature of the restroom is described as the embodiment, however, controlling prior to the user status change, as well as the control of time-consuming processing as described above may be performed. For example, it is possible to display information about shops near the transit train station prior to the user's arrival to the transit station by estimating the next transit station from the information about shops near the transit station.

Note that each unit in FIG. 2 may or may not be included in a computer. For example, the sensor 110 may be in the apparatus 130. The current status judgment unit 122 may be included in the sensor 110. The future status estimation unit 124 and the inter-status relationship management unit 123 may be located in a computer on the network. Furthermore, each unit may be located in computers separately.

Note that there may be plural units in FIG. 2. For example, the future status estimation unit 124 may be as many as the number of the user, or there may be only one future status estimation unit shared with each user.

Note that the embodiments above is realized when a CPU interprets and executes a given program data which can implement the processing described above, stored in a memory device (ROM, RAM, hard disk and the like). In this case, the program data may be introduced to the memory device via a storage medium, or may be executed directly on the storage medium. Note that the storage medium includes semiconductor memory such as ROM, RAM, flash memory and the like, magnetic disk memory such as flexible disk or hard disk and the like, storage medium such as optical discs including CD-ROM, DVD, BD and the like or memory cards. In addition, the concept, storage medium includes telephone line and path and the like.

### INDUSTRIAL APPLICABILITY

The apparatus control system according to the present invention may be applied to an apparatus control system for controlling a coordinated operation of plural apparatuses, particularly to a network system in which personal computers and the like are mutually connected via a LAN for household and the like.

1. An apparatus control system comprising:
a sensor which obtains action information indicating an environment related to a user or an action of the user;
an apparatus control device which estimates a future status of the user based on the action information obtained by said sensor and a transition probability that varies depending on an elapsed time from the current status, and generates estimation information indicating the estimated status; and
an apparatus which operates according to the estimation information generated by said apparatus control device.

2. The apparatus control system according to claim 1,
wherein said apparatus control device includes:
an action-status relationship management unit operable to hold action-status relationship information indicating a relationship between the action information and a possible user status;
a current status judgment unit operable to judge the current status of the user based on the action-status relationship information;
an inter-status relationship management unit operable to hold inter-status relationship information indicating a relationship between two possible user statuses;
a future status estimation unit operable to estimate the user's future status using the current status judged by said current status judgment unit and the inter-status relationship information, and to identify estimation information indicating a result of the estimation;
a status-apparatus relationship management unit operable to hold status-apparatus relationship information indicating a relationship between the estimated future status and an apparatus to be controlled; and
a control apparatus decision unit operable to decide an apparatus to be controlled using the estimated future status and the status-apparatus relationship information, and notify the apparatus of the estimation information.

3. The apparatus control system according to claim 2,
wherein said apparatus control device further includes an information collection unit operable to collect history information indicating an action history of the user, and
said inter-status relationship management unit is further operable to modify the inter-status relationship information using the collected history information.

4. The apparatus control system according to claim 1,
wherein said apparatus includes:
a judgment condition management unit operable to hold a judgment condition related to control of said apparatus;
an estimation information obtainment unit operable to obtain the estimation information from said apparatus control device;
an operation content decision unit operable to decide operation content of said apparatus using the obtained estimation information and the judgment status; and
an operation control unit operable to control said apparatus in accordance with the decided operation content.

5. The apparatus control system according to claim 4,
wherein the estimation information includes an elapsed time from the current status and a probability that transition to the future status occurs, and
said operation content decision unit is operable to identify operation content based on the transition probability to the future status when the judgment status is satisfied.

6. The apparatus control system according to claim 1,
wherein said apparatus control device further estimates an intermediate status estimated in accordance with the elapsed time from the current status, further estimates the a future status of the user in accordance with the elapsed time from the intermediate status, and generates estimation information indicating the estimated future status.

7. An apparatus control method comprising:
an information obtainment step of obtaining action information indicating environment related to a user or action information indicating an action of the user;
an estimation information generating step of estimating the future status of the user based on the obtained action information and a transition probability which varies depending on the elapsed time from the current status, and generating estimation information indicating the estimated status;
an apparatus control step of controlling an apparatus according to the estimation information generated in said estimation information generating step.

8. A program for an apparatus control device, said program being caused by the apparatus control device to execute:
a current status judgment step of judging the current status of the user using action-status relationship information indicating a relationship between action information indicating an environment related to a user or action information indicating the action of the user;
a future status estimation step of estimating the future status of the user using inter-status relationship information indicating relationship between two possible user statuses and the current status judged in said current status judgment step, and identifying estimation information indicating the estimated result; and
a control apparatus decision step of determining an apparatus to be controlled using status-apparatus relationship information indicating a relationship between the estimated future status and the apparatus to be controlled, and notifying the apparatus of the estimation information.
